(19) United States
(12) Patent Application Publication
(10) Pub. No.: US 2022/0278353 A1
(43) Pub. Date: Sep. 1, 2022

(54) BATTERY DEVICE

(71) Applicant: MAHLE International GmbH, Stuttgart (DE)

(72) Inventors: Caroline Janzen, Stuttgart (DE); Thomas Kalmbach, Stuttgart (DE); Heiko Neff, Auenwald (DE)

(21) Appl. No.: 17/680,273

(22) Filed: Feb. 24, 2022

(30) Foreign Application Priority Data
Feb. 24, 2021 (DE) 10 2021 201 737.1

(51) Int. Cl. H01M 10/04; H01M 50/284; H01M 50/367

(52) U.S. Cl. CPC H01M 10/0481; H01M 50/284; H01M 50/367; H01M 2010/4271

(57) ABSTRACT

A traction battery device or an accumulated battery device is provided having a cell stack of rechargeable individual battery cells that are stacked onto one another in a stack direction. An end plate each is touchingly arranged on two stack front-faces of the cell stack oriented opposite to one another in the stack direction. It is substantial for the disclosure that the individual battery cells of the cell stack are clamped or can be clamped to another in the stack direction with at least one anchor board that is equipped or can be equipped with electronic elements.

### CROSS REFERENCE TO RELATED APPLICATIONS

This application claims priority to German patent application DE 10 2021 201 737.1, filed Feb. 24, 2021, the entire content of which is incorporated herein by reference.

### TECHNICAL FIELD

The disclosure relates to a battery device, in particular to a traction battery device for a motor vehicle, having a cell stack of rechargeable individual battery cells that are touchingly stacked onto one another in a stack direction, wherein on two stack front-faces of the cell stack-oriented opposite to one another in the stack direction an end plate each is touchingly arranged.

### BACKGROUND

Practically, individual battery cells of battery devices of this type are mutually clamped in the stack direction via anchor bolts in order to provide a firmly contiguous cell stack, quasi an individual battery cell composite of individual battery cells that are practically non-displaceable relative to one another. For example, the publication DE 10 2009 035 460 A1 describes a battery device having a plurality of individual battery cells which are realized in a bipolar flat design and which are stacked into a cell stack and braced via an anchor bolt. In practice, the individual battery cells are electronically interconnected, for the purpose of which different electronic components are employed. Because of the plurality of battery device components, for example anchor bolts and boards etcetera the known battery devices are relatively large constructions and of relatively heavy gross weight, although compact and light battery devices are desired.

### SUMMARY

It is an object of the disclosure to provide an improved or at least another embodiment of a battery device.

This object is achieved by a battery device as described herein.

A basic idea of the disclosure lies in optimizing battery devices through suitable function integration with respect to installation space and total weight.

Specifically, it is provided that a battery device, in particular a traction battery device for a motor vehicle, comprises a cell stack of rechargeable individual battery cells stacked onto one another in a stack direction. Here, the individual battery cells stacked onto one another can be separated from one another by way of an insulation so that there is therefore no touching contact between these. Such an insulation can be realized through an insulation film, propagation sheets or compression pads or the likes. Here, an end plate each is touchingly arranged on two stack front-faces of the cell stack-oriented opposite to one another in the stack direction. It is essential that the individual battery cells of the cell stack are clamped to one another or can be clamped to one another in the stack direction with at least one in particular integral anchor board that is equipped or can be equipped with electronic elements. By way of this, the anchor board unites multiple functions within itself which in the past were realized through different device components. Accordingly, the anchor board practically realizes the mutual clamping of the individual battery cells into a relatively firm cell stack, as did an anchor bolt until now. At the same time, the anchor board serves as board that is equipped or can be equipped for example with electronic elements serving for the contacting of the individual battery cells, as did the separate boards until now. By way of this, the battery device can omit at least one separate anchor bolt and a separate board.

Obviously, the anchor board can be supported by a further anchor bolt. The same can be arranged on a side of the cell stack opposite to the anchor board. Practically, this anchor bolt can also be realized as anchor board. The anchor board can be employed as substitute for a conventional anchor bolt and/or quasi support existing anchor bolts in terms of clamping force. By way of this, the battery device can also comprise at least one anchor board, and also at least one anchor bolt. The battery device is therefore comparatively compact and relatively light.

Practically, an anchor board can be clampingly coupled to the respective end plates. By way of this, the anchor board can transmit clamping forces via the end plates to the individual battery cells. Further practically, the coupling of the respective anchor board to one or to both end plates can be realized in a positive and/or non-positive or firmly bonded manner. Practically it is conceivable that an anchor board is bonded or screwed to at least one end plate. By way of this, the anchor board can be coupled to the end plates.

Further practically, an anchor board can comprise one or more board bodies serving to be equipped with individual electronic elements. Practically, at least one or all board bodies can be formed by so-called PCB bodies or printed circuit board bodies.

Practically, the respective anchor board is formed by a single or multiple board bodies at least in portions. It is also conceivable that the respective anchor board is formed in multiple portions, in particular by one or more board bodies with gaps between the respective portions in the stack direction. In addition, the respective anchor board can be completely, i.e., entirely, formed by a single continuous board body. Because of this, the anchor board can be equipped with electronic elements at any point, as a result of which the anchor board is relatively flexible and can be utilized for contacting the individual battery cells.

Further practically, at least one or all board bodies can be formed of a board material. Practically, the board material is a glass fiber braiding or a glass fiber braiding that is embedded in an epoxy matrix. Other board materials are likewise conceivable, in particular an aluminum board material or other suitable base materials could be employed here. Because of this, the board bodies can be embodied so as to be relatively stable mechanically. Because of this, the board bodies can further have a relatively low thermal expansion in particular in the direction of the stack direction. In addition, such board bodies can have both a thermally and also electrically insulating and, further, flame-retardant effect, which advantageously favors the operational safety of a battery device.

Practically, a board body can be equipped with the following electronic elements:
electronic circuits for controlling individual battery cells, and/or
electronic circuitry for controlling individual battery cells, and/or
contact tags for electrically contacting the individual battery cells, and/or
controllers for controlling or regulating individual battery cells, and/or
sensors for monitoring individual battery cells, and/or
conductor tracks.

Because of this, a contacting of the individual battery cells and/or a cell monitoring and/or cell monitoring control of the individual battery cells can be realized for example.

Further practically, separate board components can be arranged on at least one board body. The board components can each comprise electronic elements and/or electronic circuits such as electronic circuitry and/or contact tags for electrical contacting of the individual battery cells and/or controllers and/or sensors and/or conductor tracks.

Practically, at least one anchor board can be formed at least in portions by way of an anchor bolt for the mutual clamping of the individual battery cells of the cell stack. Each anchor bolt can transmit clamping forces for clamping the individual battery cells. At least one anchor bolt can be produced from a material of high specific strength. Here, specific minimum strengths from 43,000 Nmm/g are conceivable for example.

Practically, at least one anchor board can comprise or form a degassing channel. This has the advantageous effect that for example highly reactive and hot battery gas escaping from the individual battery cells can be discharged. Motor vehicle components located adjacent to the battery device are therefore relatively protected.

Further practically, the degassing channel can be touchingly arranged on a flat anchor board surface of the respective anchor board facing away from the cell stack. For example, the respective degassing channel can be soldered to or bonded to the anchor board surface of the respective anchor board facing away from the cell stack. Here it is practical when the degassing channel extends along the stack direction and at least in portions over the cell stack or over a cell stack length of the cell stack in the direction of the stack direction. Practically, the cell stack length is oriented parallel to the stack direction and refers to the total length of the cell stack, for example in millimeters. Further, the degassing channel can extend along the stack direction over one and/or both end plates at least in portions or completely. Because of this, each individual battery cell can be quasi covered by the degassing channel so that all battery gas can be discharged.

Practically, the degassing channel can have a trapezium-shaped cross-sectional area. The same is practically constant along the stack direction.

Further practically, the degassing channel can be formed symmetrically with respect to a transverse plane symmetrically halving the cell stack at a right angle to the stack direction. Because of this, the degassing channel is advantageously arranged on the cell stack, as a result of which for example the discharge of battery gas is favored.

It is practical, furthermore, when the degassing channel is touchingly arranged on a flat anchor board surface of the respective anchor board facing away from the cell stack and formed as a degassing center channel. The degassing center channel divides the anchor board surface along the stack direction in the middle into two-part anchor board surfaces that are identical in terms of area. Here, at least one or both part anchor board surfaces each comprise at least one mounting slot for electronic elements. The mounting slots can be equipped with electronic elements.

The anchor board can comprise a board body which serves for being equipped with individual electronic elements and an anchor bolt, which are embodied as an integral one-piece component.

In summary, it remains to note: the present disclosure preferentially relates to a traction battery device or to an accumulator battery device having a cell stack of rechargeable individual battery cells that are touchingly stacked onto one another in a stack direction. On two stack front-faces of the cell stack-oriented opposite to one another, an end plate each is touchingly arranged. It is substantial for the disclosure that the individual battery cells of the cell stack in the stack direction are clamped to one another or can be clamped to one another with at least one anchor board that is equipped or can be equipped with electronic elements.

Further important features and advantages of the disclosure are obtained from the drawings and from the associated figure description by way of the drawings.

It is to be understood that the features mentioned above and still to be explained in the following cannot only be used in the respective combination, but also in other combinations or by themselves without leaving the scope of the present disclosure.

Exemplary embodiments of the disclosure are shown in the drawings and are explained in more detail in the following description, wherein same reference numbers relate to same or similar or functionally same components.

### BRIEF DESCRIPTION OF THE DRAWINGS

The disclosure will now be described with reference to the drawings wherein:

FIG. 1 shows a perspective view of an exemplary embodiment of an inventive battery device, and

FIG. 2 shows a rearward view of the battery device according to an arrow II entered in FIG. 1.

### DESCRIPTION OF EXEMPLARY EMBODIMENTS

The two drawings show a battery device identified as a whole by 1, which comprises a cell stack 2 of rechargeable individual battery cells 4. The battery device 1 can exemplarily form a traction battery device for a motor vehicle. The individual battery cells 4 are stacked onto one another in a stack direction 3, wherein between these an insulation, in particular an insulation film, can be arranged, which prevents a direct contact. The individual battery cells 4 are practically non-displaceably clamped to one another in the stack direction 3 and also transversely thereto. Here, the term practically can mean that a minor longitudinal clearance is present in the stack direction 3 and/or a transverse clearance transversely to the stack direction 3. The cell stack 2 of individual battery cells 4 defines two rectangular stack front-faces 5 oriented opposite to one another in the stack direction 3. On each stack front-face 5 an end plate 6 is touchingly fixed.

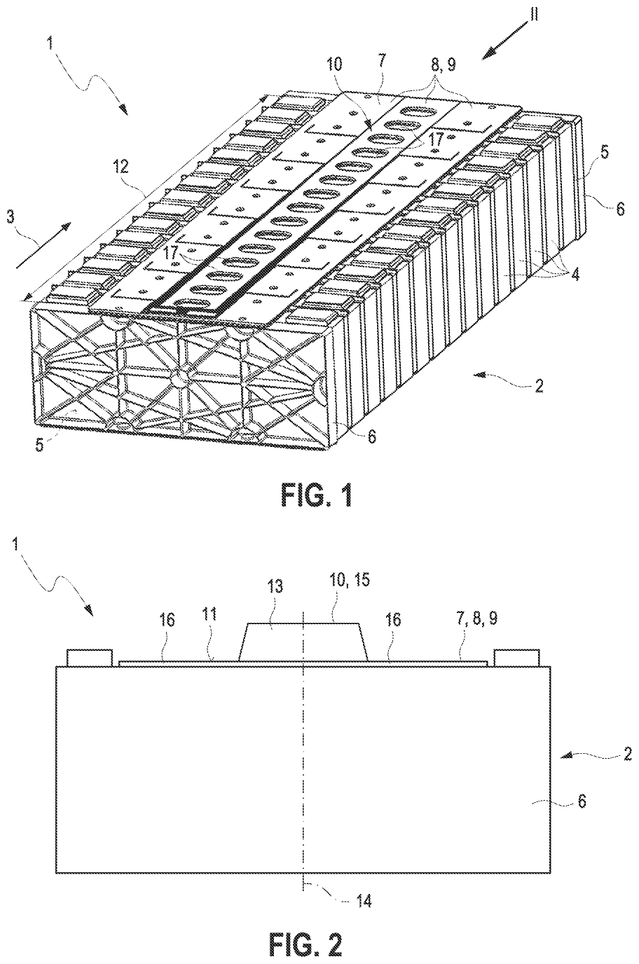

In FIG. 1 an anchor board 7 that is clampingly coupled to the two end plates 6 of the cell stack 2 is indicated, which serves for clamping the individual battery cells 4 in the stack direction 3 and for receiving or equipping with electronic elements for contacting and/or controlling and/or regulating the individual battery cells 4.

The anchor board 7 comprises a board body 8 which serves for being equipped with individual electronic elements and an anchor bolt 9, which are exemplarily embodied as integral component. Here, the board body 8 is realized as PCB board body and equipped with electronic elements that are not illustrated. The board body 8 can be formed for example of board material, in particular a glass fiber braiding embedded in an epoxy matrix. The anchor bolt 9 serving for the mutual clamping of the individual battery cells 4 is exemplarily embedded in the board body 8 or conformed by the same. In FIG. 1 it is noticeable furthermore that the anchor board 7 practically but not necessarily has a series of degassing openings 17, through which battery gas escaping from the individual battery cells 4 can pass or flow. Here, the degassing openings 17 are evidently formed by separate recesses which each penetrate the anchor board 7 completely and which in each case are assigned to an individual battery cell 4 and/or in each case to a safety valve of an individual battery cell 4. By way of this configuration, the degassing openings 17 have, in the stack direction 3, for example with respect to their center point, an identical or practically identical gap between one another each, while they are placed approximately centrally on the anchor board 7 transversely to the stack direction 3.

FIG. 2 shows a rearward view of the battery device 1 according to an arrow II entered in FIG. 1, wherein a degassing channel 10 arranged on the anchor board 7 and one of the two end plates 6 are noticeable. The degassing channel 10 serves for discharging battery gas escaping out of the individual battery cells 4, which flows for example through the degassing openings 17 described above from the individual battery cells 4 into the degassing channel 10. Here, the degassing channel 10 is touchingly arranged on an anchor board surface 11 of the anchor board 7 facing away from the cell stack 2. Here, the degassing channel 10 extends along the stack direction 3 over the entire cell stack length 12 of the cell stack 2 in the direction of the stack device 3, see FIG. 1, wherein it practically covers the degassing openings 17. Exemplarily, the degassing channel 10 has a trapezium-shaped cross-sectional area 13 which is constant along the stack direction 3. With respect to a transverse plane 14 symmetrically halving the cell stack 2 at a right angle to the stack direction 3, the degassing channel 10 is exemplarily formed symmetrically, see FIG. 2, so that the degassing channel 10 can also be referred to as degassing center channel 15. The degassing center channel 15 is arranged on the anchor board surface 11 so that it divides the same along the stack direction 3 in two part anchor board surface 16 that are identical in terms of area. Each part anchor board surface 16 exemplarily comprises multiple mounting slots for electronic elements. On the mounting slots, electronic elements for contacting and/or controlling and/or regulating the individual battery cells 4 which are not illustrated here are arranged.

It is understood that the foregoing description is that of the exemplary embodiments of the disclosure and that various changes and modifications may be made thereto without departing from the spirit and scope of the disclosure as defined in the appended claims.

What is claimed is:

1. A battery device, comprising:
a cell stack of rechargeable individual battery cells touchingly stacked onto one another in a stack direction,
wherein on two stack front-faces of the cell stack-oriented opposite to one another in the stack direction an end plate each is touchingly arranged, and wherein the individual battery cells of the cell stack are clamped or can be clamped against one another in the stack direction with at least one anchor board that is equipped or can be equipped with electronic elements.

2. The device according to claim 1, wherein an anchor board is clampingly coupled to the two end plates.

3. The device according to claim 2, wherein the coupling of the respective anchor board to one or to both end plates is realized in a positive and/or non-positive or firmly bonded manner.

4. The device according to claim 1, wherein an anchor board is bonded or screwed to at least one end plate.

5. The device according to claim 1, wherein an anchor board comprises or forms a board body which serves for being equipped with individual electronic elements, in particular a PCB board body.

6. The device according to claim 1, wherein:
the respective anchor board is formed by a single board body at least in portions, or
the respective anchor board is formed in multiple portions, in particular with gaps between the respective portions in the stack direction, by a board body, or
in that the respective anchor board is completely formed as a whole by a single board body.

7. The device according to claim 5, wherein a board body is formed of board material, namely a glass fiber braiding embedded in an epoxy matrix or another board material.

8. The device according to claim 5, wherein a board body carries electronic elements, namely:
electronic circuits for controlling individual battery cells, and/or
electronic circuitry for controlling individual battery cells, and/or
contact tags for electrically contacting the individual battery cells, and/or
controllers for controlling or regulating individual battery cells, and/or
sensors for monitoring individual battery cells, and/or
conductor tracks,
in order to thereby realize a cell monitoring and/or a cell monitoring control of the individual battery cells.

9. The device according to claim 5, wherein on at least one board body, separate board attachment parts are arranged, which in each case comprise electronic elements and/or electronic circuits such as electronic circuitry and/or contact tags for electrically contacting the individual battery cells and/or controllers and/or sensors and/or conductor tracks.

10. The device according to claim 1, wherein at least one anchor board is formed by an anchor bolt for the mutual clamping of the individual battery cells of the cell stack at least in portions or comprises an anchor bolt.

11. The device according to claim 1, wherein at least one anchor board comprises or forms a degassing channel in order to discharge battery gas escaping from individual battery cells.

12. The device according to claim 11, wherein the degassing channel is touchingly arranged on an anchor board surface of the respective anchor board facing away from the cell stack.

13. The device according to claim 11, wherein the degassing channel extends over the cell stack or over a cell stack length of the cell stack in the direction of the stack direction along the stack direction at least in portions.

14. The device according to claim 11, wherein the degassing channel has a trapezium- shaped cross-sectional area, which is constant along the stack direction.

15. The device according to claim 11, wherein the degassing channel is formed symmetrically with respect to a transverse plane symmetrically halving the cell stack at a right angle to the stack direction.

16. The device according to claim 11, wherein the degassing channel is touchingly arranged on an anchor board surface of the respective anchor board facing away from the cell stack and formed as degassing center channel, which divides the anchor board surface along the stack direction in two part anchor board surfaces that are the same in terms of area, and
wherein at least one or both part anchor board surfaces each comprise at least one mounting slot for electronic elements.
